(19) United States
(12) Patent Application Publication
(10) Pub. No.: US 2007/0237503 A1
(43) Pub. Date: Oct. 11, 2007

(54) Lens fitted photo film unit and manufacturing method therefor

(75) Inventor: Shintaro Tadokoro, Minami-Ashigara-shi (JP)

Correspondence Address: YOUNG & THOMPSON, 745 SOUTH 23RD STREET, 2ND FLOOR, ARLINGTON, VA, 22202, US

(73) Assignee: FUJIFILM CORPORATION, Tokyo (JP)

(21) Appl. No.: 11/723,260

(22) Filed: Mar. 19, 2007

(30) Foreign Application Priority Data
Mar. 22, 2006 (JP) 2006-079496

(51) Int. Cl. G03B 17/02; G03B 9/02

(52) U.S. Cl. 396/6; 396/505

(57) ABSTRACT

A stopper, a stop aperture and a lens support portion are integrally formed to a lens base. The stopper hits a shutter blade when the shutter blade swings in an open direction and the shutter speed is set. The stop aperture controls light amount of subject light that passes through the taking lens and reaches the photo film. The lens support portion positions the taking lens in an optical axis direction. Position of the stopper and size of the stop aperture and position of the lens support portion are different depending on model of a lens fitted photo film unit. Each model of the lens fitted photo film unit is manufactured by selecting the lens base.

### FIELD OF THE INVENTION

The present invention relates to a lens fitted photo film unit preloaded with an unexposed photo film and a manufacturing method therefor.

### BACKGROUND OF THE INVENTION

A lens fitted photo film unit that allows user to easily enjoy shooting photos no matter when or where is sold. The lens fitted photo film unit has a simple structure, basically formed with a taking lens, a shutter mechanism and an unexposed photo film, but it is not provided with an automatic focus function and an automatic exposure mechanism.

The unexposed photo film is pulled out from a film cartridge and contained in a film roll chamber provided to one side of a body base. The film cartridge is loaded in a cartridge chamber provided to the other side of the body base and rewinds the exposed photo film each time when a photo is shot.

The taking lens is composed of one or two plastic lenses capable of mass-production. When a photo film cartridge having 35 mm width (135 type) or 24 mm width (IX240 type) is built in, a quasi wide-angle lens having a focal distance of, for example, at most 35 mm is used. Using the quasi wide-angle lens can reduce thickness of the lens. Compared to a compact camera's lens with the same focusing distance, a stop aperture is made smaller, and f-number is set to about, for example, f/10 to increase depth of field. Accordingly, excellent image quality can be obtained in a wide range including a long range and a close range without providing a focusing mechanism.

A sensitive photo film, ISO 400 type is generally used, but a high sensitive photo film, for example ISO 800 or 1600 type is also used. Moreover, there is a lens fitted photo film unit having a built-in flash device so that a photo can be shot in a dark room.

For the shutter mechanism, a so-called kick type shutter mechanism having one swingable shutter blade, in which one end of the shutter blade is kicked to open and close an exposure opening, is used for reducing cost. The shutter mechanism includes a shutter driving lever, a charge spring, the shutter blade, and a return spring. The shutter driving lever moves interlocking with a film winding operation from an initial position to a charge position against bias of the charge spring and then returns to the initial position from the charge position with accumulated force of the charge spring, interlocking with a shutter release operation.

Japanese Patent Laid-open Publication No. 06-258686 discloses a shutter blade that includes an arm projecting from a circular open/close part, and a claw formed at one end of the arm. When a shutter driving lever returns, the claw is kicked by one end of the shutter driving lever and the shutter blade swings around an axis provided on the arm and the open/close part opens a shutter aperture. After releasing the shutter opening, the shutter blade returns by bias of the return spring and the open/close part covers the shutter opening.

Japanese Patent Laid-open Publication No. 11-326987 discloses a lens fitted photo film unit that is capable of changing shutter speed at two stages. Japanese Patent Laid-open Publication Nos. 2001-013636 and 2002-350925 disclose a lens fitted photo film unit that is capable of shifting stops.

Moreover, there is a lens fitted photo film unit loaded with a high sensitive photo film, in which shutter speed is changeable and a stop is shiftable to improve background descriptiveness in indoor photos or night photos. In this lens fitted photo film unit, a sharp background can be recorded with sufficient brightness by illuminating a main subject when the photo is shot indoors or at night.

For example, in Japanese Patent Laid-open Publication Nos. 2003-330152 and 2004-085620, a lens fitted photo film unit that is provided with three shooting modes, a daylight shooting mode without flash emission suitable for shooting photograph in a bright place such as outdoors under daylight, a daylight synchro shooting mode with flash emission suitable for a back-lighted shot and a night view synchro shooting mode suitable for shooting a main subject with flash emission, while reproducing a background of a night view or a dark room at a proper density, is disclosed. In addition, a lens fitted photo film unit capable of shooting, close-up photos of a flower and such is sold. The above lens fitted photo film unit with different shooting modes is sold by the present applicant under the product name “Night & Day”.

As mentioned above, wide variety of the lens fitted photo film units are commercialized and a user can select one as usage and enjoy shooting photograph.

In contrast, in order to save resource and reduce factory waste, recycle of the lens fitted photo film unit is actively promoted. When a user brings the lens fitted photo film unit that contains the exposed photo film to a development service store, the lens fitted photo film unit is sent to a development station, where the exposed photo film is taken out, developed, and printed. The lens fitted photo film unit from which the photo film is taken out is collected by a manufacturer and broken down into the parts. Then, recyclable parts are sent to a manufacturing stage and non-recyclable parts are used as a primary material. Moreover, a unitized part, for example a shutter mechanism is recycled at a unit level.

Since the lens fitted photo film units often have exclusive parts optimized for each model and these exclusive parts can not be recycled to the other model of the lens fitted photo film unit, recycle efficiency becomes very low. In these years, user's demand has diversified and variety of the lens fitted photo film unit is increasing. Therefore, high-mix low-volume production of exclusive parts increases manufacturing cost and worsens the recycle efficiency.

### SUMMARY OF THE INVENTION

An object of the present invention is to provide a lens fitted photo film unit and a manufacturing method therefore, capable of decreasing manufacturing cost and improving recycle efficiency by use of a common part for various models of the lens fitted photo film unit.

Another object of the present invention is to provide a lens fitted photo film unit and a manufacturing method therefore, capable of setting focusing distance of the lens, size of stop aperture and shutter speed optimum for each model of the lens fitted photo film unit by exchanging one part only.

To achieve the above objects, a lens fitted photo film unit of the present invention includes a lens base having a lens support portion for positioning a taking lens in an optical axis direction, a stop aperture for controlling light amount of subject light that passes through the taking lens and reaches the photo film, and a stopper for controlling maximum swing amount of the shutter blade, the shutter blade hitting said stopper when the shutter blade swings in an open direction. According to model of the lens fitted photo film unit, the lens base, in which position of the lens support portion, size of the stop aperture and position of the stopper are different, is used.

A lens barrel is uniformly formed with the lens base and contains the taking lens. A lens cover is attached to a front end of the lens barrel and the taking lens is supported between the lens base and the lens support portion.

The receiving face is provided on an extending line of a path on which an intersecting point of an optical axis of the taking lens and the shutter blade located at a close position moves by swing of the shutter blade, and the receiving face is a parallel plane to a line connecting the intersecting point and a swing axis of the shutter blade when the shutter blade hits the stopper.

A manufacturing method of a lens fitted photo film unit includes the steps of forming a lens support portion for positioning the taking lens in an optical axis direction, a stop aperture for controlling light amount of subject light that passes the taking lens and reaches the photo film, and a stopper for controlling maximum swinging amount of the shutter blade, the shutter blade hitting the stopper when the shutter blade swings in an open direction integrally, and preparing a plurality of said lens bases in which said lens support portion, said stop aperture and stopper are different in position or size and selecting among the lens bases according to model of the lens fitted photo film unit for different shooting condition.

According to the present invention, using different lens bases according to the model of the lens fitted photo film unit makes it possible to manufacture various models for different shooting conditions. Therefore, cost increase due to high-mix low-volume production can be suppressed and recycle efficiency can be improved.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a perspective view illustrating a lens-fitted photo film unit;

FIG. 2 is an exploded perspective view illustrating the lens-fitted photo film unit;

FIG. 3 is a perspective view illustrating a partially exploded exposure unit;

FIG. 4 is a view illustrating a closing state of a shutter blade that is viewed from the front;

FIG. 5 is a view illustrating an opening state of the shutter blade that is viewed from the front;

FIG. 6 is a view illustrating a lens base for normal photography that is viewed from the shutter blade side;

FIG. 7 is a view illustrating a lens base for sports photography that is viewed from the shutter blade side;

FIG. 8 is a view illustrating a lens base for indoor photography that is viewed from the shutter blade side;

FIG. 9 is a view illustrating a lens base for daylight photography that is viewed from the shutter blade side;

FIG. 10 is a view illustrating a lens base for close-up photography that is viewed from the shutter blade side;

FIG. 11 is a cross sectional view along line 11-11 shown in FIG. 6;

FIG. 12 is an enlarged view around a stopper (in a circle “A1”) shown in FIG. 6;

FIG. 13 is a cross sectional view along line 13-13 shown in FIG. 7;

FIG. 14 is an enlarged view around a stopper (in a circle “A2”) shown in FIG. 7;

FIG. 15 is a cross sectional view along line 15-15 shown in FIG. 8;

FIG. 16 is an enlarged view around a stopper (in a circle “A3”) shown in FIG. 8;

FIG. 17 is a cross sectional view along line 17-17 shown in FIG. 9;

FIG. 18 is an enlarged view around a stopper (in a circle “A4”) shown in FIG. 9;

FIG. 19 is a cross sectional view along line 19-19 shown in FIG. 10;

FIG. 20 is an enlarged view around a stopper (in a circle “A5”) shown in FIG. 10; and

FIG. 21 is a table showing a setting condition of each lens base.

### DESCRIPTION OF THE PREFERRED EMBODIMENTS

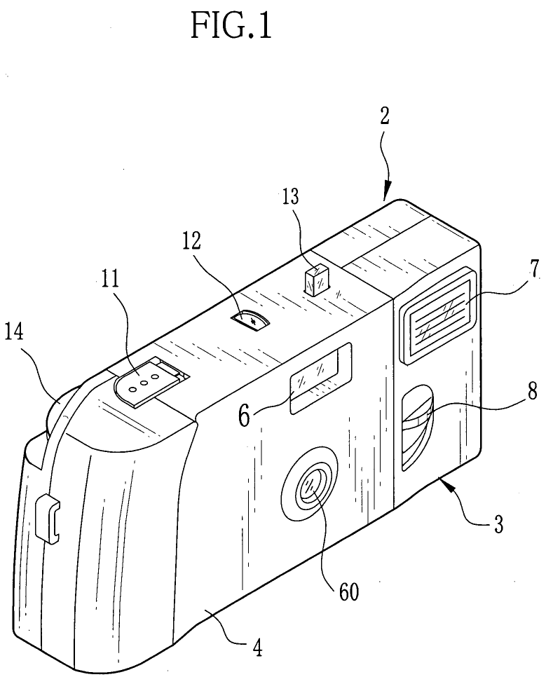

In FIG. 1, a lens fitted photo film unit 2 for normal photography includes a unit body 3 loaded with a photo film and incorporated with each photographing mechanism, and a label 4 wound around a periphery of the unit body 3. The label 4 has several openings for exposing each part of the unit body 3.

A front face of the unit body 3 is provided with, a taking lens 60, a viewfinder window 6, a flash emitter 7 and a flash operating member 8. An upper face of the unit body 3 is provided with a shutter button 11, a counter window 12 and a charge completion indicator 13. A film winding wheel 14 for winding the exposed photo film is partially projected from a back of the unit body 3.

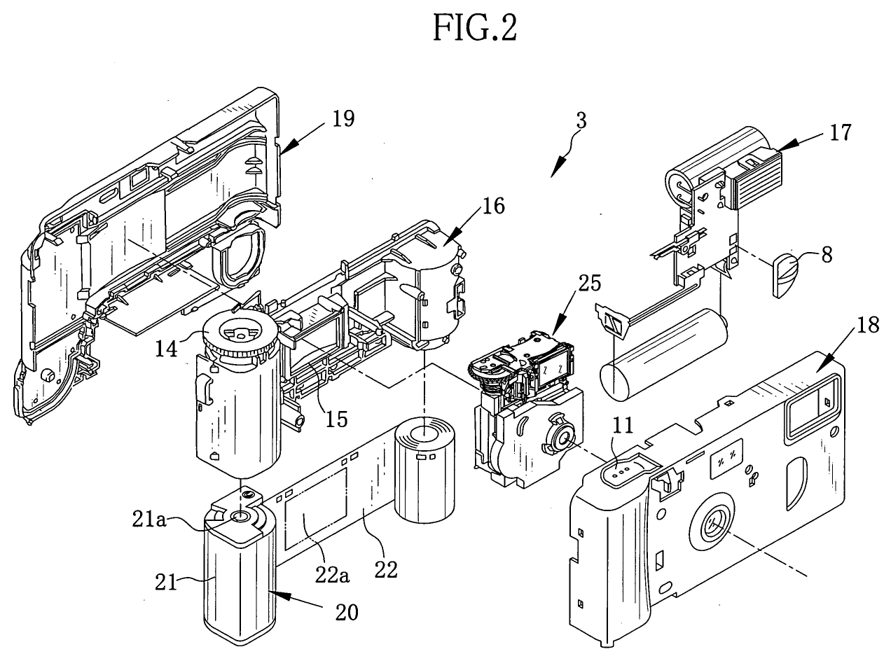

As shown in FIG. 2, the unit body 3 includes a mechanical unit 25, a body base 16, a flash unit 17, a front cover 18, a rear cover 19, and a film cartridge 20. The film cartridge 20 is an IX 240 type and includes a cartridge body 21 and a photo film 22 that is pulled from the cartridge body 21 and rolled.

A front center of the body base 16 is provided with an aperture 15. The photo film 22 is exposed after stopping at the position facing the aperture 15. The film winding wheel 14 is rotatably attached on a top of a cartridge chamber provided to the body base 16. A lower face of the film winding wheel 14 is integrally provided with a driving shaft (not shown) that engages with an end 21a of a spool of the cartridge body 21 loaded in the cartridge chamber. When the film winding wheel 14 is rotated after shooting of one frame, the exposed part of the photo film 22 is wound up in the cartridge body 21.

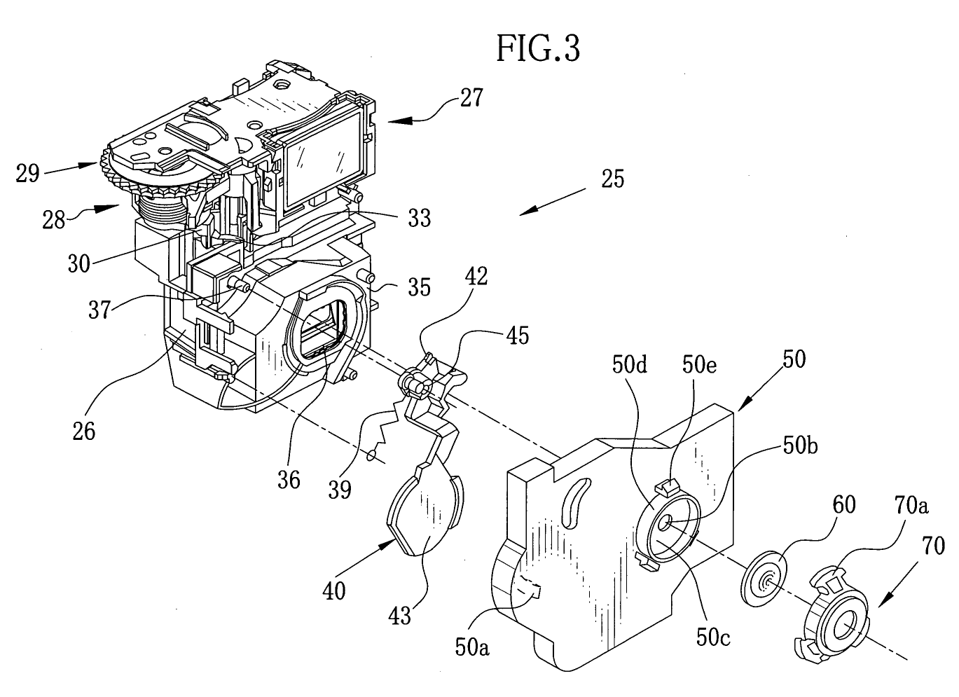

The mechanical unit 25 is locked to the body base 16 by a claw (not shown). Shown in FIG. 3, the mechanical unit 25 is composed of a mechanical base 26 that forms a dark box and other mechanical parts. A finder unit 27, a film winding stop mechanism 28, a counter mechanism 29 and a shutter charge mechanism 30 are mounted to an upper face of the mechanical base 26.

A front face of the mechanical base 26 is integrally formed with a shutter base 35. A shutter blade 40 includes a shaft receiving hole 45 that rotatably fits a shaft 37 provided on a mechanical base 26. When the shutter blade 40 is located at a close position, an open/close portion 43 covers a shutter aperture 36 provided on the shutter base 35.

A lens base 50 is attached to the shutter base 35 to cover the shutter blade 40. The lens base 50 is provided with a stopper 50a, a stop aperture 50b, a lens support portion 50c for supporting the taking lens 60, a lens barrel 50d for containing the taking lens 60, and a lens cover hook 50e, all formed integrally therewith.

P1 indicates an intersecting point of the optical axis of the taking lens 60 and the shutter blade 40 located at the close position. A curved line EL indicates a path of P1 and an extension thereof when the shutter blade 40 swings. A stopper 50a is disposed on the EL. Moreover, a receiving face of the stopper 50a is parallel to a line connecting the shaft 37 with P1 when the shutter blade 40 hits the stopper 50a. When the shutter blade 40 hits the stopper 50a, great bounce occurs.

The taking lens 60 is contained in the lens barrel 50d integrally formed with the lens base 50 and a lens cover 70 is attached to the lens base 50 to hold the taking lens 60 with the lens support portion 50c. The lens cover 70 includes an engaged portion 70a that engages with the lens cover hook 50e integrally formed with the lens base 50 to position the taking lens 60.

After shooting, the film winding wheel 14 is operated and the exposed photo film 22 is wound in the cartridge body 21. The shutter charge mechanism 30 is activated by the rotation of the film winding wheel 14, and a shutter driving lever 33 is set to the charge position.

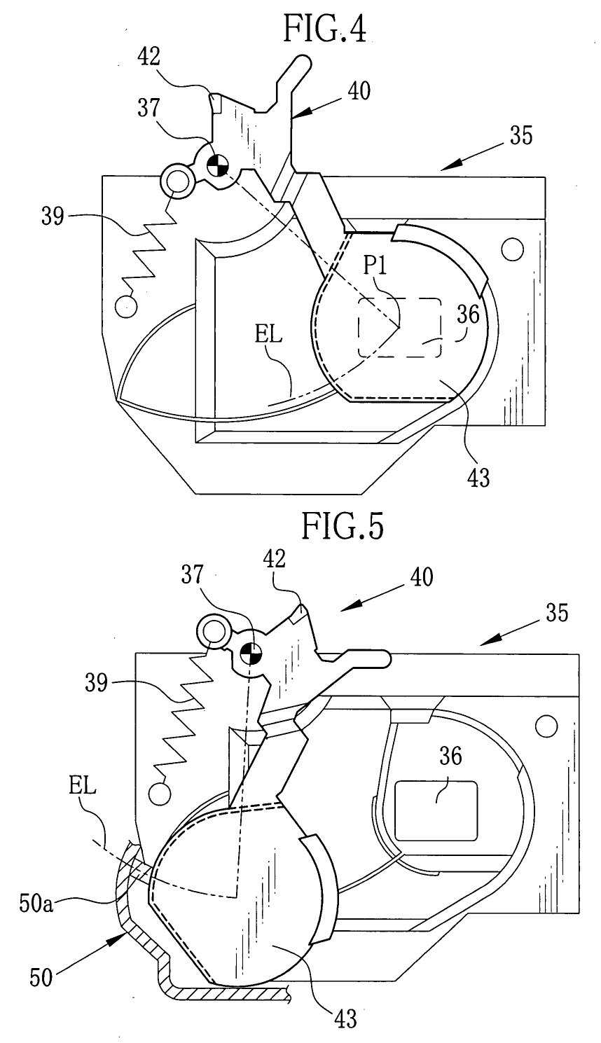

When the shutter button 11 is pressed down, lock of the shutter driving lever 33 is released to return to an initial position at high speed. Since a claw 42 of the shutter blade 40 is located in a path of the shutter driving lever 33, the claw 42 is strongly kicked by the shutter driving lever 33. The shutter blade 40 is rotated in a clockwise direction around the shaft 37 provided on the mechanical base 26 and moves from an close position shown in FIG. 4 to an open position shown in FIG. 5. The open/close portion 43 of the shutter blade 40 contacts the stopper 50a provided on the lens base 50 after opening the shutter aperture 36 is opened. The shutter blade 40 is returned to the close position by a return spring 39 after contacting the stopper 50a, and closes the shutter aperture 36.

Depending on the distance between the stopper 50a and the edge of the shutter blade 40, right after the shutter aperture 36 is opened, bounce volume which the shutter blade 40 receives from the stopper 50a changes. The shutter speed changes according to the bounce volume.

Moreover, f-number changes according to the size of the stop aperture 50b. Furthermore, an object distance/focus distance at which the taking lens 60 focuses changes according to the position of the lens support portion 50c.

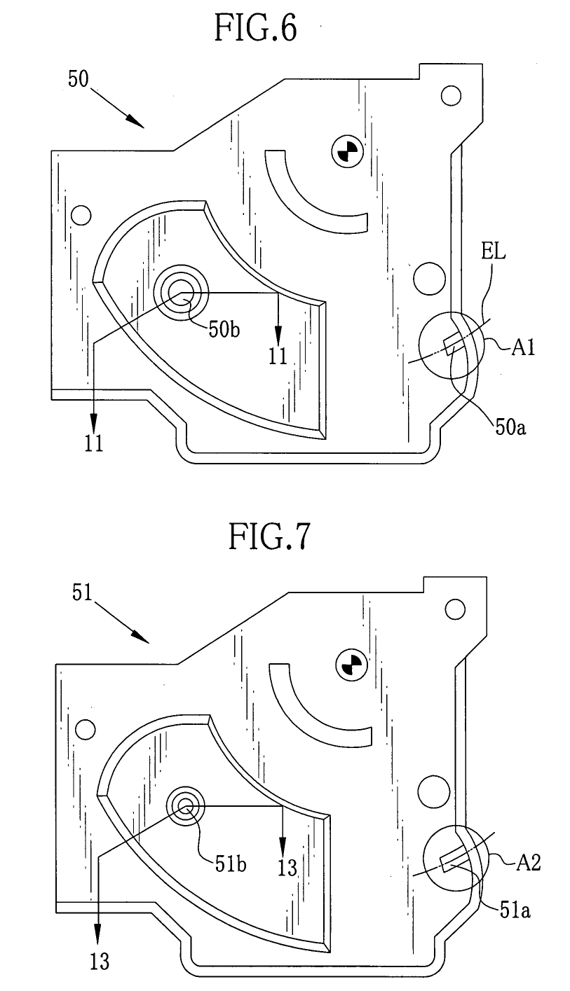

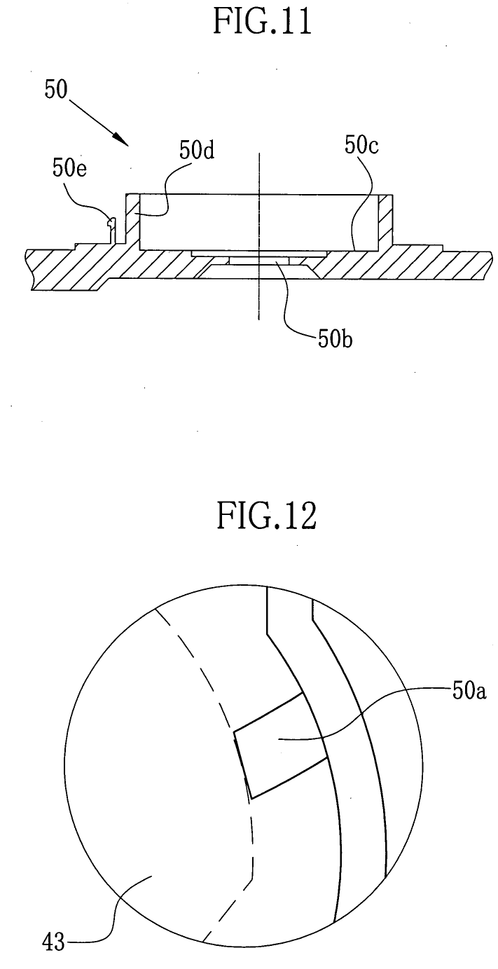

In the lens fitted photo film unit for normal photography, the lens base shown in FIGS. 6 and 11 and 12 is used. The stopper 50a is provided to set the shutter speed to 1/140 sec., as shown in FIG. 21. The stop aperture 50b is set to f/10 for a normal brightness. The lens support portion 50c is located to set the object distance/focus distance at which the taking lens 60 focuses to 3.5 m.

The lens fitted photo film unit for normal photography does not need great bounce when the shutter blade 40 hits the stopper 50a since the shutter speed is low. Therefore, the stopper 50a may be located slightly away from the curved line EL.

The stopper, the stop aperture, and the lens support portion are provided on the lens base, so using the exclusive lens base in accordance with each model of the lens fitted photo film unit makes possible to manufacture various models of the lens fitted photo film units. It is noted that the lens cover attached to the lens base is the same for all models.

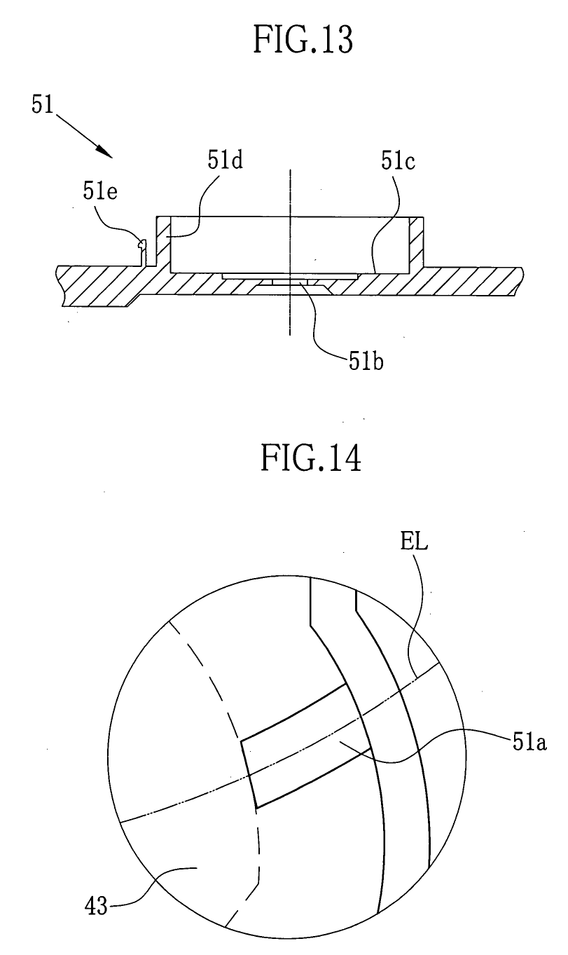

In the lens fitted photo film unit for sports photography, a lens base 51 shown in FIGS. 7, 13 and 14 is used. For shooting a moving subject, for example a sports scene, shutter speed is set higher than the lens fitted photo film for normal photography, for example 1/200 second, and stop value is set to f/14 for deepening depth of field with the same lens, and a high sensitive photo film of ISO 1600 is used.

For setting high shutter speed, 1/200 sec., a stopper 51a is located at a position to contact the shutter blade 40 immediately after the shutter blade 40 opens the stop aperture 51b. Therefore, a great bounce is generated to shorten the time for the shutter blade 40 to return the initial position.

The stop aperture 51b is set to f/14 that is smaller than the stop aperture 50b for normal photography, so it is effective for high shutter speed. The lens support portion 51c provided on the lens base 51 is located slightly deeper than the lens support portion 50c for normal photography and the focusing distance of the taking lens 60 is set to 5.6 m.

Only three conditions, shutter speed, f/number of the lens and focusing distance are different between the lens fitted photo film unit for normal photography and the lens fitted photo film unit for sports photography. It is noted that the three conditions are set by change of the size of the stopper 51a, the stop aperture 51b and the lens receiving part 51c provided on the lens base 51, without using new parts. Compared with the lens fitted photo film unit for normal photography, exposure amount is small since the shutter speed is high and the lens is slow, so a high sensitive photo film of ISO 1600 is preferably loaded.

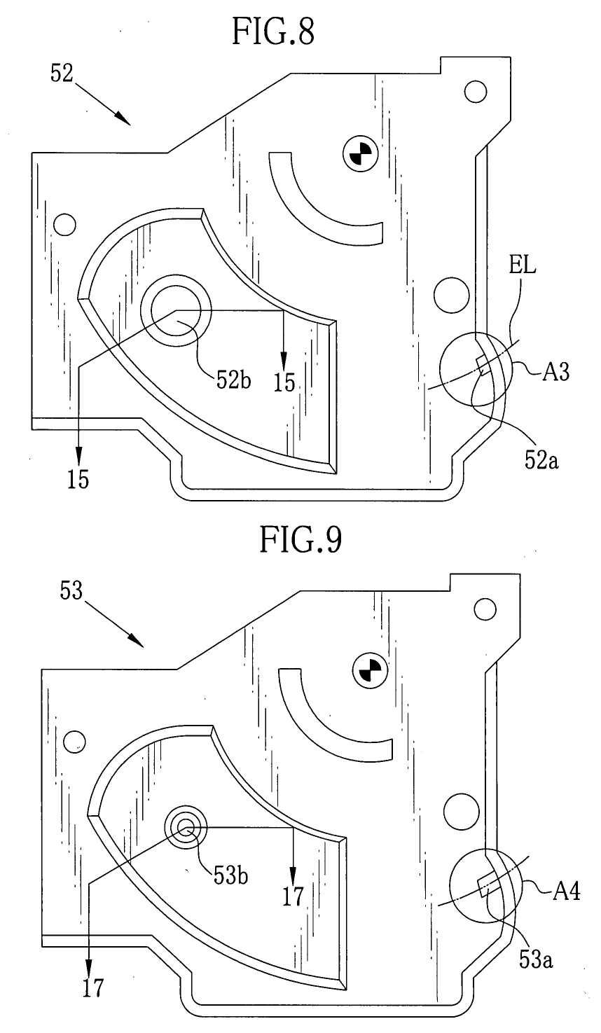

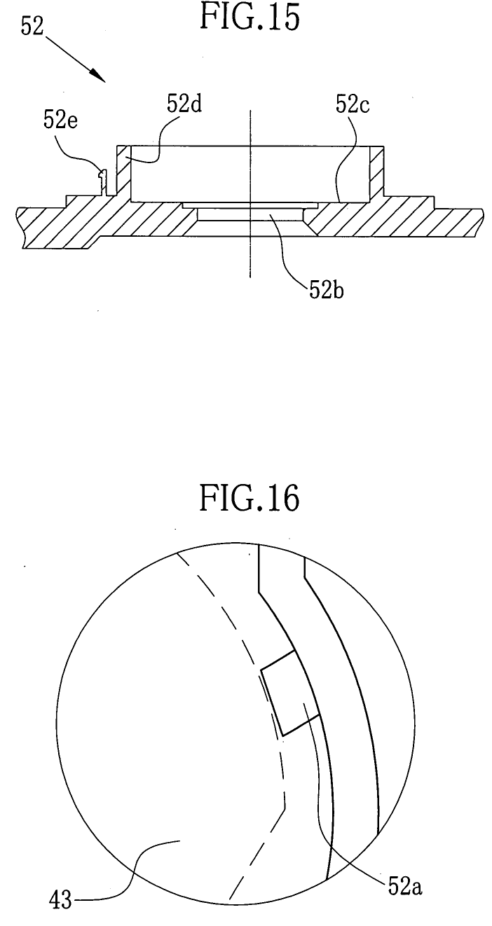

A lens base 52 shown in FIGS. 8, 15 and 16 is used for a lens fitted photo film unit for indoor photography that is appropriate for shooting in a dark room. The lens base 52 is formed with a stopper 52a, a stop aperture 52b, a lens support portion 52c, a lens barrel 52d and a lens cover hook 52e.

The lens fitted photo film unit for indoor photography is mainly used at indoors and photo is shot at relatively close range, so focusing distance is set to approximately 2 m. Therefore, the lens support portion 52c is slightly disposed ahead compared with the lens support portion 50c for normal photography.

The stopper 52a is shorter than the stopper 50a of the lens base 50 for normal photography and the receiving face of the stopper 52a contacted by the shutter blade 40 is widely apart from the optical axis. Then, the counterturn of the shutter blade 40 delays to lengthen exposure time. The stop aperture 52b is set to f/4 that is sufficiently larger than the stop aperture 50b of the lens base 50 to enable to brightly shoot a dark background in a flash photography indoors.

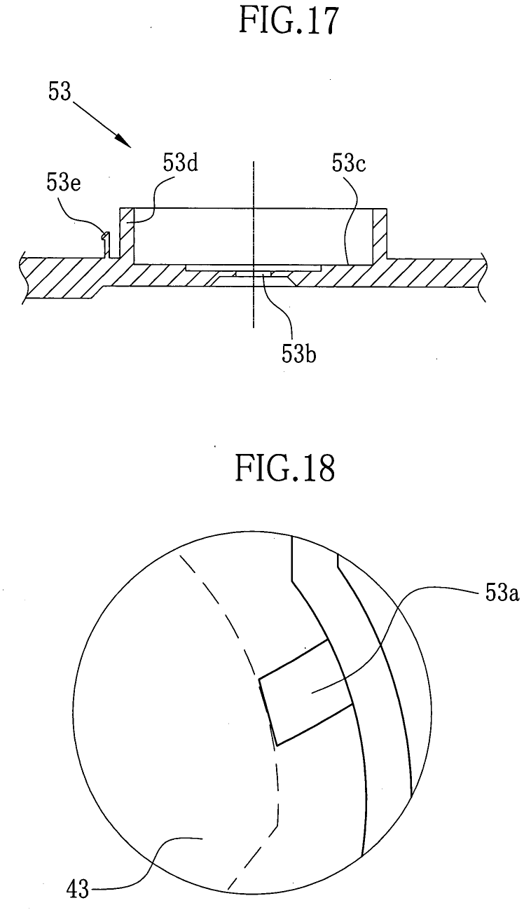

A lens base 53 shown in FIGS. 9, 17 and 18 is used for a lens fitted photo film unit with no flash device for daylight photography.

A stop aperture 53b of the lens base 53 is set to f/14 for widening focal range, in which it is same f-number as the stop aperture 51b of the lens base 51 for sports photography. In view of the outdoor photography, the lens support portion 53c is identical to the lens support portion 51c of the lens base 51 for sports photography. However, since high shutter speed is not required for the daylight photography, the stopper 53a is identical to the stopper 50a of the lens base 50 for normal photography.

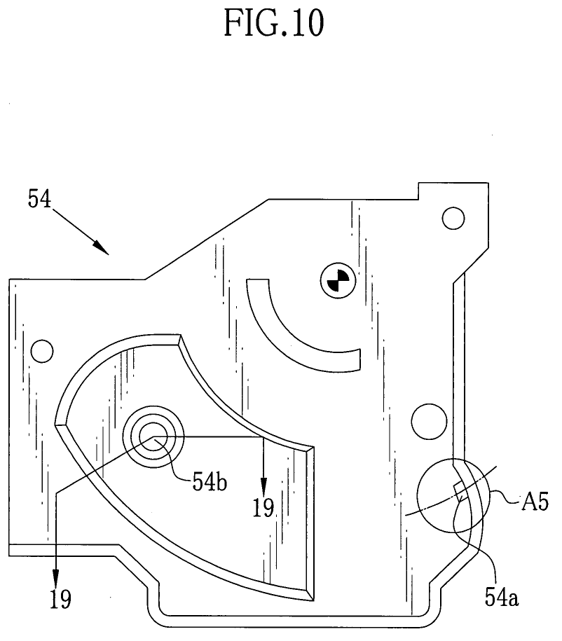

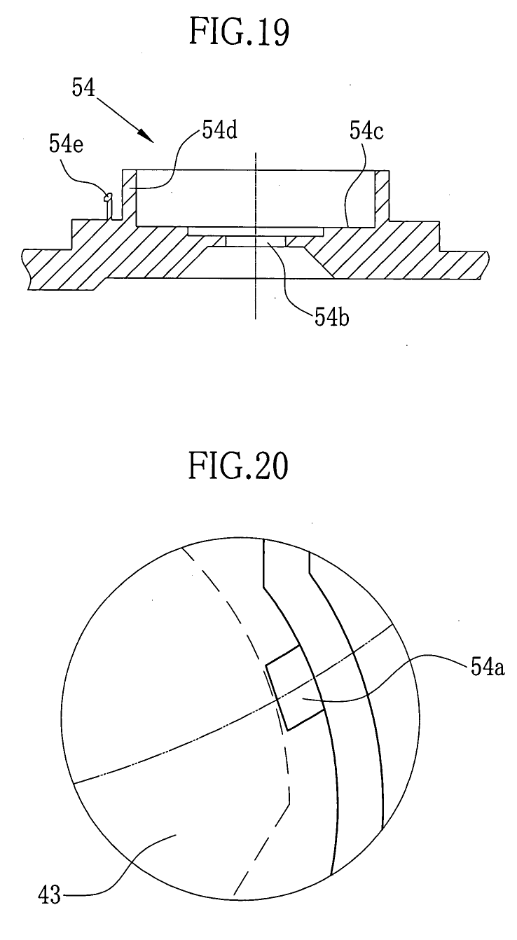

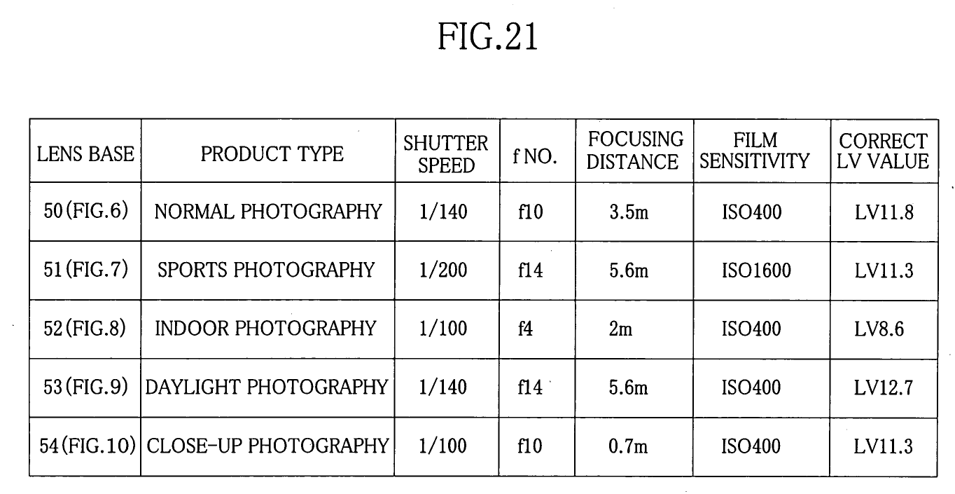

As shown in FIGS. 10, 19 and 20, a lens base 54 is used in a lens fitted photo film unit for close-up photography for example, a flower photo.

A stop aperture 54b of the lens base 54 is set to f/10 that is identical to the stop aperture 50b of the lens base 50 for normal photography and the lens support portion 54c is disposed rather ahead compared with the other lens support portions since the photo is shot at close range. This is for setting the focusing distance within lm, for example, 70 cm. A stopper 54a is located in the same position as the stopper 52a of the lens base 52 for indoor photography.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A lens fitted photo film unit that is preloaded with an unexposed photo film and provided with a taking lens supported by a lens base and a shutter blade of a kick-away type that is swingable behind said taking lens, said lens base comprising:
a lens support portion for positioning said taking lens in an optical axis direction;
a stop aperture for controlling light amount of subject light that passes through said taking lens and reaches said photo film; and
a stopper for controlling maximum swing amount of said shutter blade, said shutter blade hitting said stopper when said shutter blade swings in an open direction.

2. A lens fitted photo film unit as claimed in claim 1, wherein said lens support portion, said stop aperture and said stopper are uniformly formed with said lens base.

3. A lens fitted photo film unit as claimed in claim 2, wherein position of said lens support portion, size of said stop aperture and position of said stopper are different depending on model of said lens fitted photo film unit.

4. A lens fitted photo film unit as claimed in claim 3, wherein said lens base is further provided with a lens barrel for containing said taking lens, which is pressed to said lens base by a lens cover attached to a front end of said lens barrel.

5. A lens fitted photo film unit as claimed in claim 3, wherein said stopper includes a receiving face hit by said shutter blade, wherein said receiving face is provided on an extending line a path on which an intersecting point of an optical axis of said taking lens and said shutter blade located at a close position moves with a swing of said shutter blade, and wherein said receiving face is a parallel plane to a line connecting said intersecting point and a swing axis of said shutter blade when said shutter blade hits the stopper.

6. A manufacturing method of a lens fitted photo film unit, which is preloaded with an unexposed photo film and a taking lens supported by a lens base and provided with a shutter blade of a kick-away type that is swingable behind said taking lens, said manufacturing method comprising the steps of;
forming a lens support portion for positioning said taking lens in an optical axis direction, a stop aperture for controlling light amount of subject light that passes said taking lens and reaches said photo film, and a stopper for controlling maximum swing amount of said shutter blade, said shutter blade hitting said stopper when said shutter blade swings in an open direction, integrally with said lens base; and
preparing a plurality of said lens bases each of which differs in position or size of said lens support portion, said stop aperture and stopper, and selecting among said lens bases according to model of said lens fitted photo film unit for different shooting condition.

7. A manufacturing method of a lens fitted photo film unit as claimed in claim 6, wherein said forming step further includes a step of forming a lens barrel to contain said lens barrel.

8. A manufacturing method of a lens fitted photo film unit as claimed in claim 7, further including a step of attaching a lens cover to a front end of said lens barrel, and wherein said lens cover supports said taking lens with said lens support portion.
